(19) United States
(12) Patent Application Publication
(10) Pub. No.: US 2003/0197999 A1
(43) Pub. Date: Oct. 23, 2003

(54) Device to increase the closing force of AC powered contactors, relays and solenoids

(75) Inventor: Robert P. Scaringe, Rockledge, FL (US)

Correspondence Address: CROWELL & MORING LLP, INTELLECTUAL PROPERTY GROUP, P.O. BOX 14300, WASHINGTON, DC, 20044-4300, US

(73) Assignee: MAINSTREAM ENGINEERING CORP.

(21) Appl. No.: 10/127,425

(22) Filed: Apr. 23, 2002

(51) Int. Cl. H01H 47/00

(52) U.S. Cl. 361/139

(57) ABSTRACT

A device for increasing the closing force of an AC powered contact in a circuit having a low-voltage AC source and a switch in a structure of the type used for activating electric devices by means of a low voltage such as heating pumps, air conditioners and refrigerators. In order to improve the closing force, a half-wave rectifier operates on the AC voltage to provide an output to energize the contactor. The closing force when the contactor receives the half-wave rectified voltage exceeds a force generated by the contactor when it receives an unrectified low-voltage alternating current of the same voltage and frequency value. The resulting improved closing force is accompanied by an improvement in the life time of the electromagnetic contactor and a decrease in the resistance of the electrical flow through the contactor.

### BACKGROUND AND SUMMARY OF THE INVENTION

The present invention relates to an improved field installable/removable electrical device which increases both the closing force of an electromagnetic contactor, relay or solenoid, and the lifetime. The present invention also functions to decrease the resistance of electrical flow through the contactor or relay. (The terms relay and contactor are used interchangeably. Electrically they perform the same function, but, in practice, the term contactor typically refers to larger amperage switched contacts.)

A contactor is a common method of activating an electrical device by means of a lower voltage, lower current, and therefore safer control circuit. The control circuit is typically powered by a safe voltage, such as 24 volts AC, but any voltage could be used. The control circuit may contain overload switches that are normally closed, and the opening of any one of such safety switches will open the circuit and prevent electric power from reaching the coil of the contactor. FIG. 1 contains a schematic of the electrical control circuit of a typical vapor compression heat pump, air conditioner or refrigerator. Safety switches and controls are typically wired in series, so that the opening of any one switch will cut power to the contactor coil and open the main circuit, stopping the unit. Safety switches (such as the high-pressure and low-pressure cutout) open when there is a problem. When the safety switch, and the control switch or thermostat are all closed, a complete circuit from the power source through the contactor coil is established, energizing the coil of the contactor, and thereby developing a magnetic field which closes the contactor.

The force developed by this contactor can be calculated by a well-known relation namely F=B²A/(2μ) where B is the flux density, A is the cross-sectional area of the air gap, and μ is the permeability of the air. Since B is squared, this contactor will close with either AC or DC power. Since low-voltage AC power is easily obtainable from higher voltage AC, by means of a transformer, AC power is typically used for such contactor coils. The mathematically detailed square of flux density (B²) is physically explained by the magnetic flux lines attempting to close the air gap, and not by the direction of the flux lines, which reverse as the current reverses in an AC circuit. That is, the closing force is independent of the direction of the magnetic flux, and thus AC power or DC power will close the contactor. The magnitude of the flux lines B is important, not the direction. This is discussed in typical electrical circuit textbooks such as “Introduction to Electric Circuits” by Herbert W. Jackson (Prentice Hall, Englewood Cliffs, N.J., Copyright 1959). FIG. 2, has been taken from this text.

A problem with these control systems is that the lower-voltage AC control circuit is typically obtained from a transformer on the line voltage, and when the contactor closes bringing a high current draw device, such as a refrigeration compressor, onto the line, this causes a temporary drop in line voltage. Since the control circuit voltage is obtained from a transformer off the line voltage, as the line voltage drops, that is, as the voltage input to the primary side of the transformer drops, the voltage produced at the secondary of the transformer also drops. (A transformer's voltage output is a fixed fraction of the input voltage, based on the ratios of turns in the primary and secondary windings, therefore as the primary side voltage drops so too does the output voltage drop.) In many cases, this secondary transformer voltage may drop low enough for the contactor to no longer have sufficient magnetic force to remain closed, and the contacts open (disconnecting the load from the line). For example, a typical 24 VAC contactor coil, will open if the coil voltage is below about 19 volts, if this 24 VAC is obtained from a 10 to 1 transformer connected to a single-phase 220-240 VAC line, a drop to below 190 volts (a voltage drop of 13% to 21%), will cause the secondary-side voltage to be below 19 VAC, and the contactor will open. Once the contactor re-opens, the line voltage once again returns to the unloaded higher voltage (240 volts in the case of our example), the transformer secondary voltage likewise increases and the contactor one again closes, dropping the voltage and repeating the cycle. This causes the contactor to repeatedly open and close, either at low speeds (causing a clicking noise), or at speeds high enough to cause a loud buzzing sound. If the cycling is severe the compressor may not start, and will thermally overload due to the repeated inrush current characteristic of motor starting.

Alternatively, the unit may start, and operate with a continuous chatter due to the repeated inrush current of motor starting without the motor ever obtaining its normal running speed. In less severe cases, the rapid oscillation open and closed will lead to contactor arcing and pitting, reduced compressor voltage (resulting in increased compressor current draw), excessive contactor voltage drop, contactor heating and excessive compressor heating.

One solution to this problem is to power the contactor coil from a separate electrical circuit, so that the turn-on voltage drop of the electrical device does not affect the voltage to the control circuit. This is typically not a practical solution, since it requires a different isolated electrical circuit to power the contactor. Other solutions include replacing the AC coil with a DC contactor coil, and powering this coil from a DC power supply. Since the power dissipation in the resistive winding of the contactor coil would be twice the AC power dissipation, an existing AC coil could not be used for the steady 24 volts DC, because the increased power would destroy the coil. Therefore the AC coil would have to be changed. This DC alternative then requires an isolated DC power source and a new coil, also an impractical option.

Alternatively, if a rectification circuit was added to rectify the AC power to a varying DC power source (as shown in FIG. 3), no benefit is to be expected since the closing force of the contactor is unaffected by the direction of the flux density, since the flux density B, is squared. As specifically pointed on in basic electric circuit textbooks, such as Equation 7.11, Page 145 of “Introduction to Electric Circuits” by Herbert Jackson

F=B²A/(2μ)

Where

F=closing force

A=cross sectional area of air gap

B=flux density

μ=Permeability of the air

Therefore, rectifying an AC supply to provide a rectified DC power does not provide any benefit since, as stated earlier, the magnetic flux B is squared so that rectifying a single-phase AC supply to a fully rectified DC supply (where the voltage is always positive, but varies from zero to a maximum, that is the DC voltage represents the absolute value of an AC supply, that is it is always positive) should not provide any benefits.

This is also expressed in “Electrical Engineering Concepts and Applications” by A. Bruce Carson and David G Gisser (Addison-Wesley Publishing, copyright 1981) when the authors state that “f_{g} is always inward regardless of the direction of the flux. Also on page 675 when the author's state “Also note that an AC coil current can be used since f_{g} is proportional to i².” The authors go on to develop equation 10 on page 657, namely

F_{g}=μₒ(Ni)²A_{g}/2l_{g}

Where

F_{g}=gap closing force

N=Number of turns of winding

i=current in windings

A_{g}=area of the air gap

l_{g}=length of the air gap

μₒ=Permeability of the air

Clearly, based on this equation, the force is proportional to the square of the current and therefore fully rectifying an AC supply should not increase the closing force. The present invention is based on the realization that, because of hysteresis effects of the flux density, the fully-rectified, varying DC power source (as shown in FIG. 3), would provide increased closing force (as discussed latter) in spite of the well known formulas and well accepted fact that it is lines of force and therefore B², that determines closing force (so that the sign of B should have no effect on the closing force). However, fully-rectifying the AC power to be used to supply the existing AC coil will cause the coil to burn out, due to the increased heat dissipation. (Of course the coil could be changed to a DC coil capable of dissipating this energy, but the present invention seeks a modification that would not require the coil to be changed). The overheating is also unexpected, since the power supplied by the rectified and un-rectifed sinusoidal wave should be identical. While this is true, it is also true that the energy dissipated in an electromagnet is proportional to the area of the hysteresis loop, and since the area of the hysteresis loop has increased, so too has the power dissipated, thereby explaining the thermal overload on the coil. FIG. 7 illustrate the increased hysteresis loop area where H is the magnetic field intensity.

The present invention dissipates half the energy of the rectified AC signal and provides increased closing force. This invention can be used successfully with the existing AC contactor coil and AC power supply.

Thus an object of the present invention is to increase the closing force of an existing AC contactor, without the need to change the contactor coil, or the existing power source in any way. When using the device of the present invention, the power supplied to the existing AC coil is reduced by one half. Furthermore, the power supplied to the coil is reduced by three fourths when the present invention is compared to switching the AC power to DC power and replacing the coil. The present invention is a simple, low cost method and system for increasing contactor-closing force, that is increasing contactor performance, without the need to change any components in the existing circuit. The device of the present invention is simply inserted into the existing circuit. This device removes arcing across the control circuit switches when they are opened (this arcing is typically caused by the induced EMF of the circuit caused by the induction of the contactor coil).

A steady DC power supply, which would provide an increased closing force (since B is constant, and therefore the average B is larger, because of the steady DC voltage supply) and also a steady DC output from a single phase AC power supply, is more complex and expensive, than simply using an AC power source. Experiments show that using a steady DC power source to power an AC contactor coil results in the coil being burned out in less than 2 minutes. This is not unexpected, since the power dissipation when 24 VDC is supplied to the same coil will be twice that of 24 VAC, resulting in rapid overheating and burn out.

The objects of the present invention are achieved by using a half-wave rectification, by means of single diode. Since a half-wave rectified DC voltage, as shown in FIG. 5, has only the positive component of voltage, the total magnetic field is only powered for half the time, and therefore the magnetic force would be presumed to be smaller, in fact half of the magnetic force developed with a AC voltage input. It is therefore not obvious at all, why the use of a half-wave rectified coil would have greater closing force that an ordinary AC powered coil.

Other objects, advantages and novel features of the present invention will become apparent from the following detailed description of the invention when considered in conjunction with the accompanying drawings.

### BRIEF DESCRIPTION OF THE DRAWINGS

FIG. 1 is a prior art low voltage control circuit;

FIG. 2 illustrates the operation of a magnetic relay circuit;

FIG. 3 is a diagram of a single phase fully rectified AC output;

FIG. 4 illustrates a continuous DC voltage output;

FIG. 5 illustrates a half-wave rectified AC single phase power output;

FIG. 6 illustrates the operation of a hysteresis loop;

FIG. 7 illustrates hysteresis operation according to the system and method of the present invention;

FIG. 8 illustrates the operation of an inductive DC circuit;

FIG. 9 illustrates the operation of the DC inductive circuit of FIG. 8 including a diode in parallel with the contactor coil;

FIG. 10 illustrates the low voltage control circuit of FIG. 1 with the additional control circuit of the present invention; and

FIG. 11 illustrates a detail of the additional control circuit of FIG. 10.

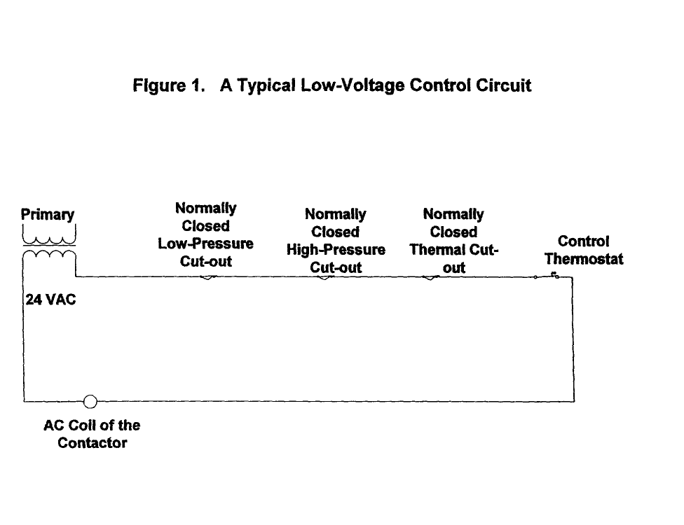

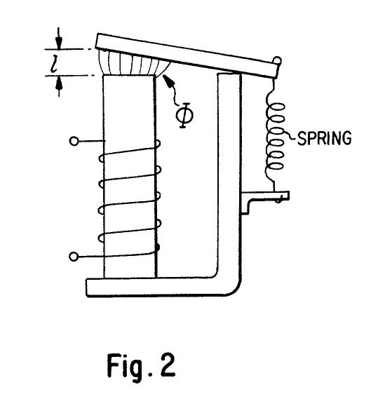

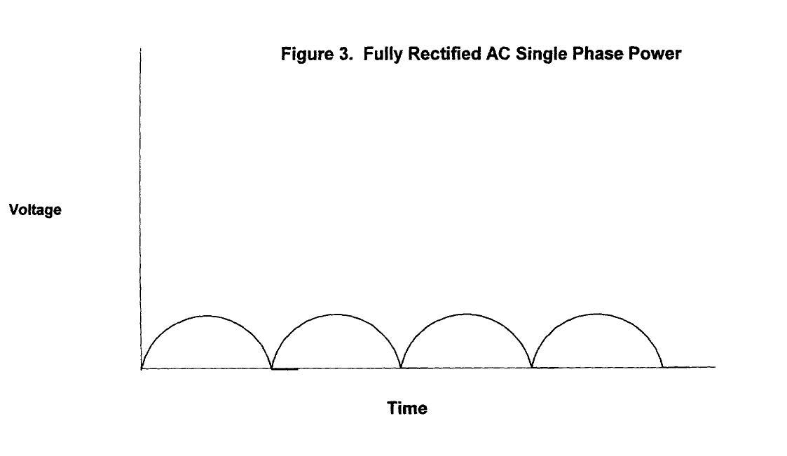

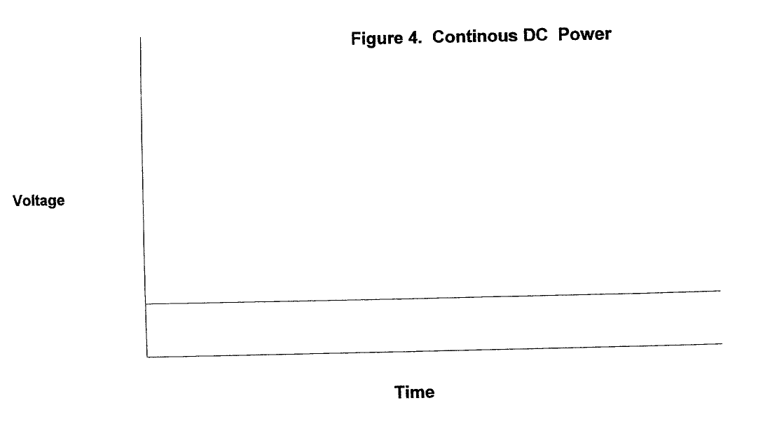

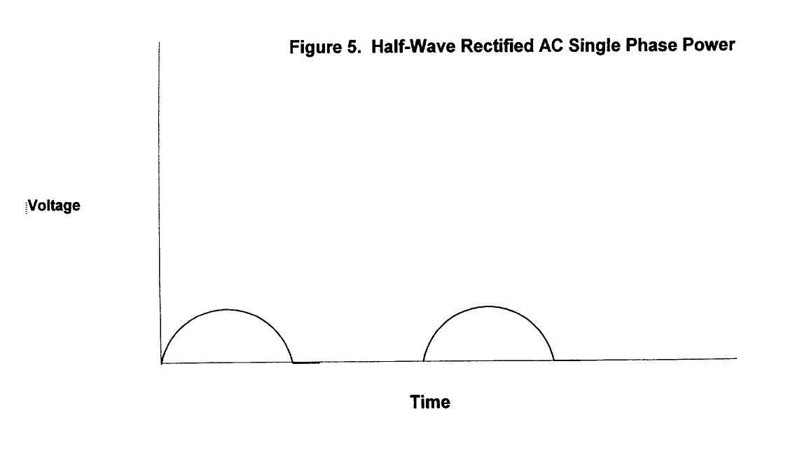

### DETAILED DESCRIPTION OF THE PREFERRED EMBODIMENT

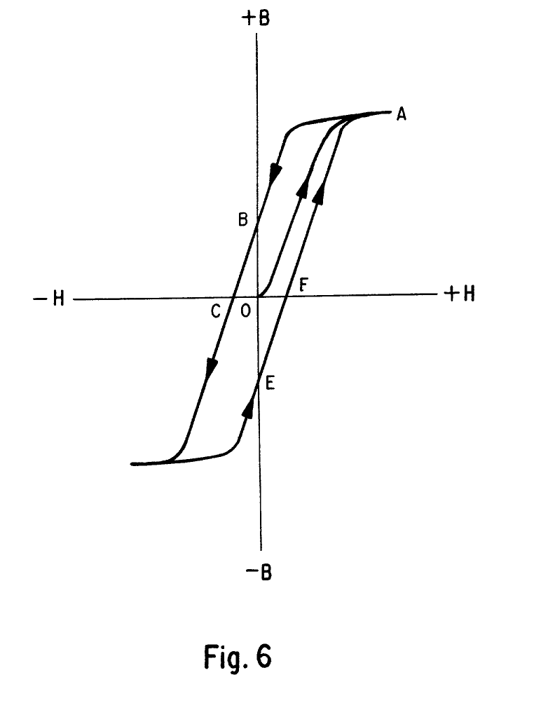

The development of the present invention is based upon taking advantage of the hysteresis effects of a magnetic field in order to improve the closing force by the use of half-wave rectified AC. FIG. 6 illustrates a well known flux density (B) verses magnetic field intensity or magnetizing force (H) curved for AC magnetization. The hysteresis graph illustrates that the magnetizing force (H) varies as the AC power varies from positive to negative during a cycle. As H increases, B increases to its positive magnetic saturation illustrated as point A in FIG. 6. Subsequently, as H decreases to zero, on its way to becoming negative, B (flux density) remains positive and a negative H is needed to overcome the residual magnetization. As H becomes increasingly more negative, eventually the negative magnetic saturation limit is reached (point D). As H again begins to increase, B once again increases to its positive magnetic saturation, and a cycle continues in the manner shown in FIG. 6.

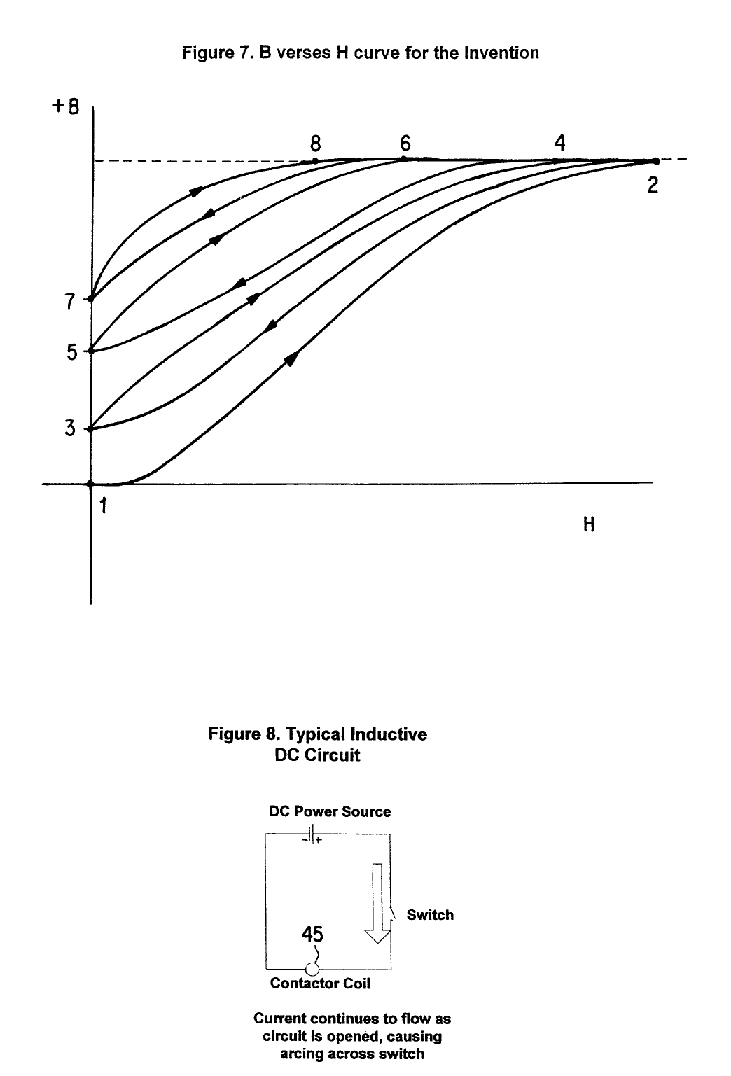

The present invention results from a realization that rather then use the reverse polarity, and therefore a negative H to remove the hysteresis of the magnetic flux density B, the hysteresis itself could be used in an advantageous manner as illustrated in the FIG. 7 curve for a half-wave rectified DC input. According to the present invention, initially, both B and H are zero (point 1), and as H increases positively, B increases to its magnetic saturation point 2. As H decreases to zero, B is reduced, however, at H equal zero, B is still greater than zero (point 3). This results from the residual magnetization or hysteresis of the electromagnetic coil. Because H never goes negative, the residual magnetization is not destroyed and when H once again increases, B once again increases to the same positive magnetic saturation, only this time occurring at point 4 which starts from a higher initial value of B. Subsequently, each time H decreases to zero, additional residual magnetization B remains at the H equal 0 point. Since the variation in H is cycling at 60 cycles per second (60 hertz), the residual magnetization quickly builds to its residual limit. Because the closing force is proportional to B and because the value of B is always approaching the magnetic saturation limit, rather then cycling from a positive maximum to a negative maximum, the closing force increases significantly. It is equally true that because the area of the hysteresis loop has increased, the power dissipated has also increased. However, because the power supply has been halved due to the negative currents being blocked, there is little net gain in power dissipation requirements. Experiments have confirmed that although the contactor coil temperature increases, the temperature of the coil remains well within safe operating limits.

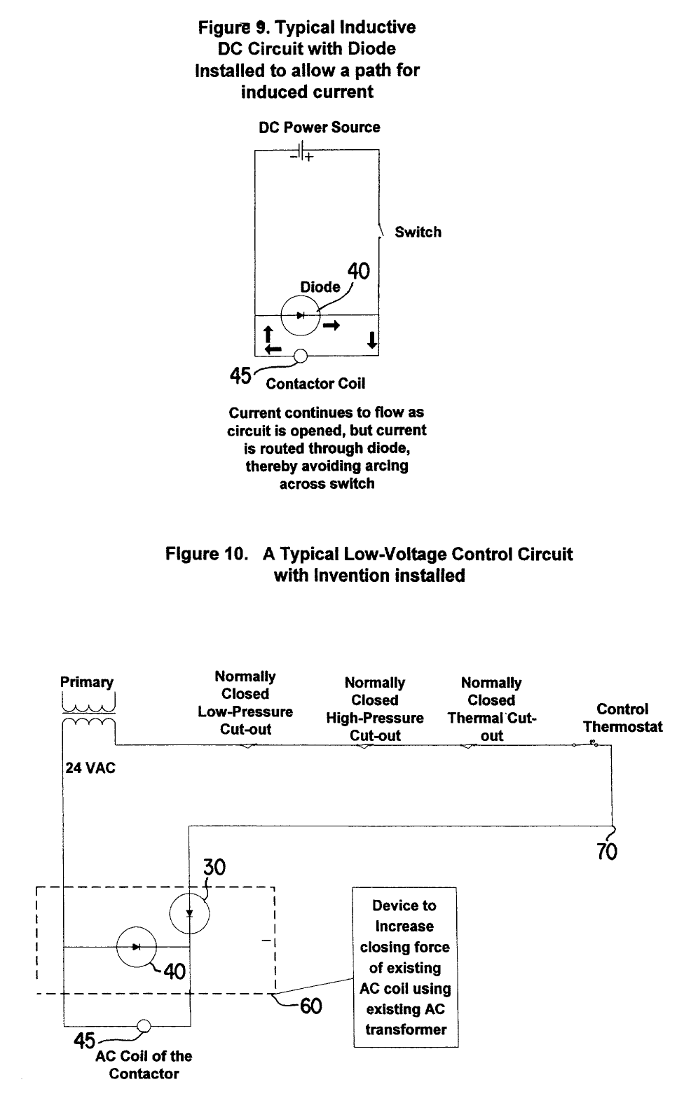

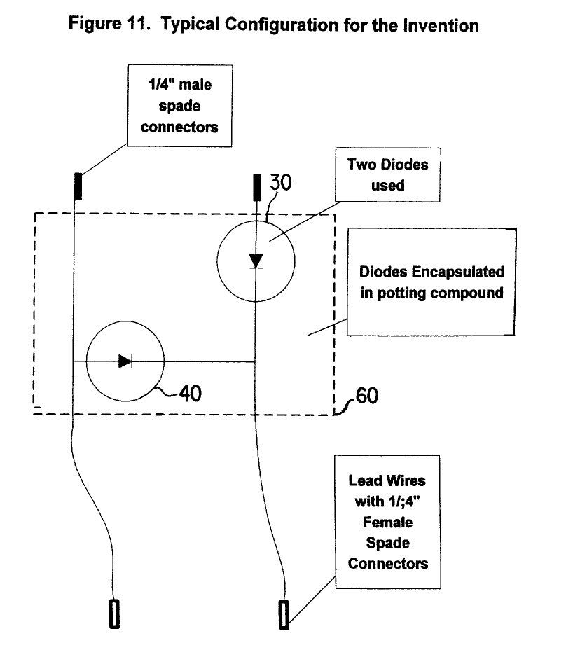

In addition to diode 30, shown in FIGS. 10 and 11, used to create a half-wave rectified coil structure, a second diode 40 shown in FIGS. 9-11 is provided for accommodating induced current caused by the coil. The FIG. 8 DC circuit powers an electrical contactor coil 45 so that when the electrical switch is opened, an induced EMF causes arcing because the electrical current attempts to continue flowing. The same circuit of FIG. 9 illustrates the diode 40 installed in parallel with the coil 45. When the contactor coil is closed, the electrical current flows into the device but the diode impedes current flow so that the diode has no negative effect when the switch is closed. However, when the switch is opened, the transient induced current will initially continue to flow through the coil with the diode 40 providing a path for the induced current flow so that the current will not arc across the open contacts of the switch. This second diode functions to increase the life of the switch contacts in the control circuit 70 of FIGS. 10 and 11.

Diodes 30 and 40 have been combined together to provide a device 60 which increases the closing force of the AC electromagnetic device which could be a contactor, a relay or a solenoid. The diodes 30 and 40 are selected so that their reverse breakdown voltage exceeds the operating voltage while the forward current capacities of the diodes are greater than the actual amperage of the coiled circuit. The two diodes can he wired into an existing control circuit with no other changes to the circuit being required. In other words, the existing contactor coil, AC transformer and control switches can be used. FIG. 10 illustrates a typical control circuit 70 with FIG. 11 showing that the device 60 can be potted into a moisture tight enclosure. The present invention allows the increase in an electromagnetic closing force of contacts, relays, solenoids or other electromagnetic devices while decreasing the power consumption and increasing the life of the components. The structure of the present invention also eliminates arcing across the opening switch contacts.

The present invention, in addition to increasing the closing force to the level of a 24 VDC coil without changing to a DC coil with less power dissipation, also provides another significant benefit. When an AC coil has a value B (magnetic flux density) of approximately zero the spring force will exceed the magnetic closing force causing the contacts to begin to open for that particular short portion of the cycle. The fraction of the cycle over which this occurs depends on the spring constant of the spring 37 used to open the contactor, the inertia of the moving parts, and the mechanical friction inherent in the contactor. However, whenever the magnetic force is less then the spring force, the contacts are urged to open while for that portion of the AC cycle where the magnetic force is greater than the spring force, the action tends to keep the contacts closed. The period of the cycle when the spring force exceeds the closing force is typically by design very small and for a 60 hertz operation, the actual time the spring force exceeds the magnetic force is very small and, by design, not sufficient to overcome the mechanical inertia necessary to actually open the contacts.

Therefore, the contacts do not open but rather just hum or vibrate at a very low amplitude. There are design constraints which make this audible hum an unavoidable reality in the prior art. That is, the spring force must be large enough to overcome static friction and open the contacts and B will be zero twice during the sinusoidal variation of AC power to the coil. Therefore, there will always be some portion of the cycle where the spring force to open the contacts exceeds the magnetization closing force and therefore, some level of hum or vibration will occur. As the net spring force increases with time, due to reduced friction caused by the wearing-in and loosening of the sliding contacts, the period of the cycle where the spring force exceeds the magnetic force will increase, further increasing the vibration. The oscillation is neither good for the life of the contactor nor for the components electrically connected to the load side of the contactor. The rapid oscillation increases contactor heating, increases contactor wear, increasing electrical resistant and is an unpleasant sound. The present invention, in addition to its above discussed advantages of increasing the closing force also removes this audible hum because B never goes to zero once the contactor is closed and therefore, the spring force never exceeds the magnetic closing force once the coil has been powered.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An electric device comprising:
a voltage source outputting a low-voltage alternating current to a first control circuit including at least one switch;
an electromagnetic contactor including a coil energized when each of said at least one switch is closed thereby developing a magnetic field in said contactor to close said contactor; and
a second control circuit including a rectifier device for providing a half-wave rectified voltage of said low-voltage alternating current wherein, when said each switch is closed, a closing force developed by said half-wave rectified voltage is greater than a closing force which would be developed by said low-voltage alternate current when said each switch is closed.

2. The device according to claim 1, wherein said second control current includes an arc inhibitor circuit for providing a path for induced current flow when one of said at least on switch is opened to thereby prevent arcing across said one switch.

3. The device according to claim 1, wherein the rectifier device is a first diode.

4. The device according to claim 3, wherein the diode has a reverse breakdown voltage greater than an operating voltage.

5. The device according to claim 2, wherein the arc inhibitor circuit includes a second diode.

6 The device according to claim 1, including an AC transformer for providing said low-voltage AC.

7. The device according to claim 1, wherein the contactor includes a spring exerting a force against said magnetic field and wherein said magnetic field developed by said half-wave rectified alternating current is never zero resulting in said magnetic closing force always exceeding said spring force.

8. A method of increasing the closing force of a contactor, comprising the steps of:
providing a source of low-voltage AC;
connecting at least one switching device to said source;
providing a half-wave rectified voltage of said low-voltage AC source; and
providing a contactor energizer by said half-wave rectifier voltage.

9. The method according to claim 8, includes the further step of providing an arc inhibitor to drain induced current resulting from opening of one of said at least one switch.

10. The method of claim 8, wherein the step of providing a half-wave rectifier voltage includes providing a first diode.

11. The method according to claim 9, wherein the step of providing an arc inhibitor includes the step of providing a second diode.

12. A device for increasing a closing force of an AC powered contactor, comprising:
a half-wave rectifier means for providing a half-wave rectified low-voltage alternating current;
a contactor means; and
a switch means for switchable controlling connection of said half-wave rectified low-voltage to said contactor means for energizing said contactor means with an energizing force exceeding a force generated by an unrectified low-voltage alternating current of the same voltage and frequency.

13. The device according to claim 12, further including an arc prevention means for providing a path for induced current flow when said switching means is opened to prevent arcing across said switching means.

14. The device according to claim 12, wherein said half-wave rectifier means is a first diode.

15. The device according to claim 13, wherein said arc prevention means is a second diode connected in parallel across said contactor.

16. The device according to claim 12, further including a transformer for providing an unrectified low-voltage AC.

17. The device according to claim 12, wherein said contactor means includes a spring exerting a spring force opposite said energizing force wherein a magnetic field developed by said half-wave rectified alternating current is never zero whereby said energizing force is always greater than said spring force to thereby prevent vibration of said contactor means.
